(19) United States
(12) Patent Application Publication
(10) Pub. No.: US 2006/0013140 A1
(43) Pub. Date: Jan. 19, 2006

(54) Predictive, intelligent routing of calls to users

(76) Inventor: Vinodh Francis Pushparaj, Santa Clara, CA (US)

Correspondence Address: MARGER JOHNSON & MCCOLLOM, P.C., 210 SW MORRISON STREET, SUITE 400, PORTLAND, OR, 97204, US

(21) Appl. No.: 10/767,392

(22) Filed: Jan. 28, 2004

(51) Int. Cl. H04L 12/26

(52) U.S. Cl. 370/241

(57) ABSTRACT

A network device includes a user interface to allow users to specify at least one contact device during a period of time. The network device also includes a predictor that predicts a probability of contact the user through at least one contact device. A first port allows the device to receive calls intended for the user and a second port to send contact signals to at least one contact device, depending upon a user specification. The network device has a processor to determine connection information based upon the contact device at which the user responds to the contact signal and transmit the connection information to the predictor to allow the predictor to update its probability predictions.

### BACKGROUND

Many voice systems offer a user a ‘following’ service, where a phone call is received at a central location and then follows the user to a specified contact device or devices. Typically, these services allow the user to designate at what device or devices the system should try contact that user during a specified time frame.

For example, a user may specify that between the hours of 8-12, and 1-5 pm, the system should contact the user at the user's desk phone, or alternatively at the user's assistant's phone. Similarly, the system should try to contact the user at the user's cell phone or pager between 12-1 pm, as the user is most likely away from his or her desk eating lunch.

This system works fairly well, provided that the user has the patience to define contact devices for each relevant time period, as well as a foreknowledge of their schedule. In addition, the user either has to have a fairly stable schedule from day to day, or would have to reset the preferences every morning. The system can only execute on the data input by the user.

This may result in both system inefficiency and user frustration. Users may become frustrated because the system may not function as desired as far as speed of response and throughput are concerned. The user may end up having the system broadcast to all of the user's contact devices for every call, eating up system resources to have that many active calls at one time. If the user does designate a set of devices, but did not predict the devices needed very well, the system may be performing well, but the user would not see it. The user would just know that the system is not reaching him or her, while the processing resources are being used up to attempt to contact the user at the specified devices.

### BRIEF DESCRIPTION OF THE DRAWINGS

The invention may be best understood by reading the disclosure with reference to the drawings, wherein:

FIG. 1 shows an example of a network having a following service.

FIG. 2 shows an embodiment of a network device using predictive routing for following.

FIG. 3 shows a flowchart of an embodiment of a method of using predictive routing.

FIG. 4 shows a flowchart of an alternative embodiment of a method of using predictive routing.

FIG. 5 shows a flowchart of a method of applying monitoring to a predictive call routing system.

### DETAILED DESCRIPTION OF THE EMBODIMENTS

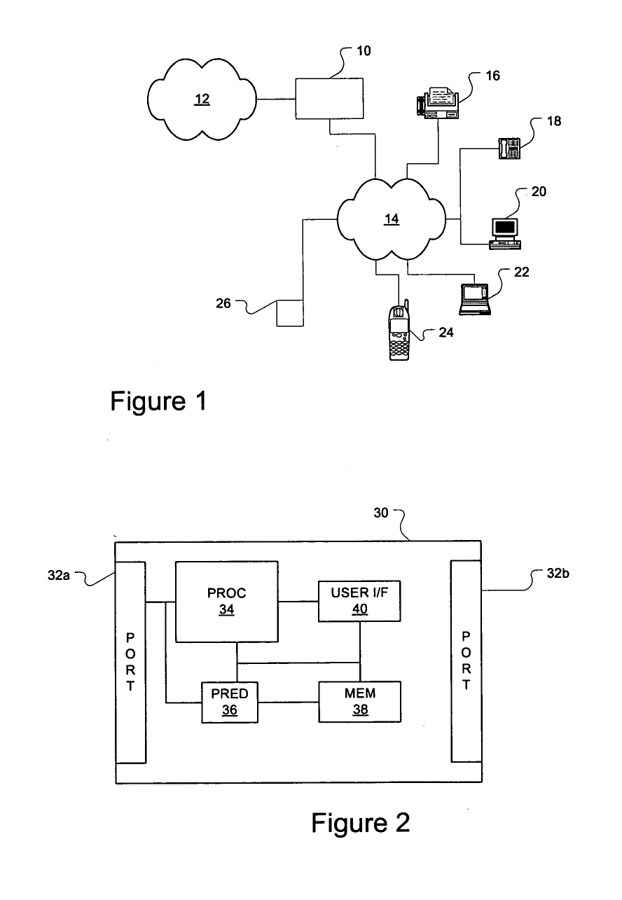

FIG. 1 shows an example of a communications network having a following service. The network device 10 is connected to one or more networks, where the contact devices for the user and the incoming call could all be on the same network or on different networks. For ease of discussion, and with no intention of limiting application of embodiments of the invention, the device will be shown as bridging the communications between two networks.

The first network 12 is the network from which the call is originating. This could be the publicly switched telephone network (PSTN), a voice over data packet network such as Voice over Internet Protocol (VoIP), over Asynchronous Transfer Mode (VOATM) or over Frame Relay (VoFR), or a data network. The incoming call could be one of many types of signals trying to reach the user, such as a telephone call, a fax signal, an instant message, or a video conference call.

The second network 14, which may be a subnetwork of the first, is referred to here as the contact network. This is the set of all of the devices at which the user may be contacted. Examples include, but are not limited to, desk phones or other land line phones 18, cell phones 24, pagers 26, fax machines 16, desktop computers 20, mobile computers and mobile computing devices such as personal digital assistants 22, etc. The user may designate different sets of contact devices per a particular time period, or just let the system broadcast to the various devices associated with tat user. The user designations, referred to here as user preferences, may take the form of just an allow/disallow during different time periods, or may be an ordered list, such as “try my cell phone first, then my pager . . . ” These are intended just as examples and are not intended to limit applicability of the invention to any particular means of designating user preferences.

The network device 10 is responsible for determining at what contact device or devices the user should be contacted when a call comes in. An example of such a network device is shown in FIG. 2. The network device 30 has a first port 32a to allow the network device to receive the incoming call intended for the user. A second port 32b allows the network device to transmit the contact signal or signals. The two ports may actually be the same port, as the network device may use the same network upon which the call was received to contact the user.

A predictor 36 predicts the probability of contacting the user by at least one contact device. The processor then transmits the contact signal to at least one contact device through the port 32b. The processor also determines the connection information when the contact signal is successful in reaching the user. The processor then transmits the connection information, such as at what device the user answered and the time at which the user answered, back to the predictor that can use the information to update the probability data for the device or devices involved. The processor may also employ memory 38 in conjunction with the predictor, as will be described below.

The predictor 36 may be part of the processor 34, or may be embodied on a separate device, such as a digital signal processor (DSP) or application specific integrated circuit (ASIC), as examples. Similarly, the processor 34 may be a general-purpose processor, a DSP, an ASIC, etc.

In one embodiment of the invention, the network device 30 may be a pre-existing device in the system with a following service. The processor would be upgraded to include the software instructions necessary to implement the invention. The instructions, when executed, would cause the device to execute the probability-dependent following services. The instructions would more than likely be included on an article of machine-readable code, where the machine is the device. The article may take the form of an image file for a DSP, for example.

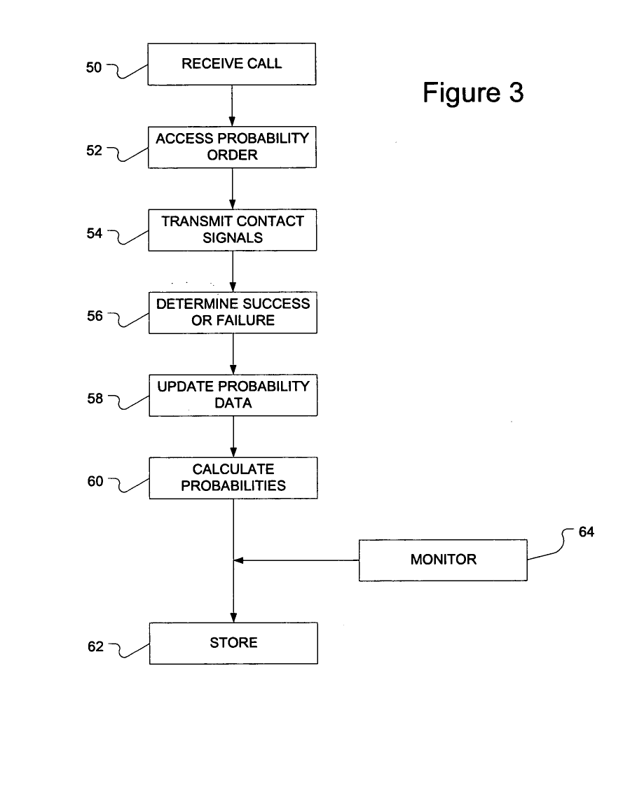

One embodiment of a method of providing probability dependent following services is shown in FIG. 3. At 50, a call for the user is received. In this embodiment, the contact device or devices to be used to reach the user are already determined, as well be discussed later. The processor then accesses the order of devices to be activated at 52. At least one contact signal is transmitted to at least one contact device at 54. If the user answers, a success has occurred at 56 and the processor updates the probability data for that device by raising the probability for that particular device at which the user was reached at 58.

In this particular embodiment, the probabilities for the various devices are determined off-line. The user may designate that the system contact him or her by using their preferences, using their preferences with probabilities, or contact him or here just by using probabilities based upon his or her usage. The probability data for the contact device at which the user was actually reached is updated at 58. The probability order is then recalculated for that time slot at 60, and the list stored for access upon call reception at 62. Continuous monitoring may be performed anywhere in the process, such as after probability calculations, at 64. This will be discussed in more detail with reference to FIG. 5.

The probability of any contact device being the one at the user responds during a conditional time slot may be viewed as a conditional probability: the probability that a user will be reached at contact device A between the hours of X and Y. The probability that the user may be reached at contact device A may be conditioned upon the time slot during which the call is received.

Bayes's Theorem sets forth one method of calculating conditional probabilities. The conditional probability P_{E}(H), is the probability of contacting a user based upon usage data E, in this case the usage data for a particular time slot. The conditional probability is calculated as:

$${P}_{E} ( H ) = \frac{P ( H \& E )}{P ( E )} .$$

This may be best understood as an example. A user, Joe, receives 1000 calls during a month. Of those, 960 calls reach Joe. Of the 1000 calls, 800 of them reach Joe during business hours, and 640 of the 800 at his desk phone. The system wants to use the probability of reaching Joe at his desk, given the condition that it is during work hours.

The unconditional probability, P(H), that a call reaches Joe is the overall probability divided by the population of calls, or 960/100=0.96. The probability of calls not only reaching Joe but reaching Joe at his desk phone, P(H&E), is then 640/1000 or 0.64. The probability of a call reaching Joe during business hours is 800/1000 or 0.80 The probability of reaching Joe at his desk phone because a call is during business hours is then:

$${P}_{E} ( H ) = \frac{0.64}{0.80} = 0.80 .$$

The same probabilities would be calculated for each device off-line, and the determined order of probabilities would be stored in memory for the next access by the processor. When a call comes in for Joe during business hours, the desk phone may have the highest probability. If it is successful, that is, Joe answers his desk phone, the data is updated to reflect that 801 out of 1001 calls were successful to Joe's desk phone during business hours, and P(H&E) becomes 641/1001, etc.

Joe has several options on how he can designate whether or not the system applies the probability to his usage patterns. Joe can designate that he wants the system to apply only the preferences he wants, a combination of the preferences and probability, or only to use probability. If Joe designates a combination, the probabilities could be multiplied by a weighting factor prior to rank ordering the list of devices to be sent the contact signals. For example, if Joe ranks the devices in 1-2-3 order, the probability determined could be multiplied by 1-2-3, or 0.4, 0.3, and 0.2.

In addition to the user designating whether or not probability can be applied, the application of the probability can be varied as well. For example, the system could divide the devices up into a number of ranges of probability. The system would then address those devices in parallel. This may be particularly useful when the system is in its early learning phase and the probability for all devices is the same.

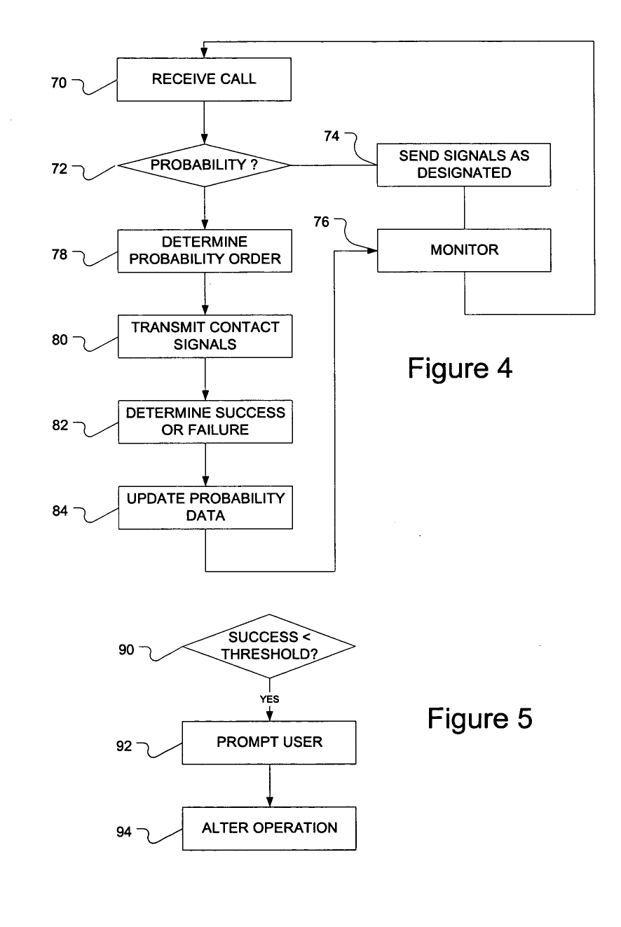

In an alternative embodiment, shown in FIG. 4, the probability calculations could be done ‘on the fly’ instead of precalculated and stored as an ordered list. In this embodiment, the call is received at 70, and user preferences accessed at 72 to determine if probability is to be applied. If probability is not to be applied, the system begins sending contact signals to the contact devices identified by the user for that time slot at 74, if any, or broadcasting contact signals to all of the contact devices associated with the user. Even though probability had not been designated, the system may still monitor the results at 76 for times in which there is no designation of preferences, or to prompt the user, as will be discussed below.

If the user had designated probability dependence to be employed in selecting which contact devices are used at 72, the probability order is determined at 78. The probability order is the order of devices in which they are signaled trying to reach the user. As mentioned above, there may be several devices having a probability within a range of probability being contacted in parallel. Further, the probability order will use the probability data mentioned before, such as the number of overall calls, the number of call during the current time slot, and the number of calls at each device that reach the user during that time slot, etc. The user preferences may also become part of the probability data, as mentioned above.

Once the probability order is determined at 78, the contact signal or signals are transmitted at 80, and the success or failure of the signals is determined at 82. The probability data is the updated with the results at 84. If monitoring is employed, the process would move to the monitoring process at 76 and the process would return to waiting for the next call at 70.

FIG. 5 shows an embodiment of monitoring by the system. The monitoring may include two different aspects of the system performance. First, the system may monitor it overall success rate at 90 to determine if the success rate is above a predefined threshold for success. If the success rate is lower than the threshold, the system may prompt the user at 92 to either enter a different set of preferences, allow the system to apply the probability mode only, if user preferences had been used in conjunction with the probabilities before, or to enter a broadcast mode. In broadcast mode, all devices are contacted in parallel, not using any type of rank ordering. The system would then re-enter a learning phase and apply the probabilities to best tune the system for faster response times, or otherwise alter operation at 94.

In a second aspect of monitoring system performance, monitoring may be done even when the user has designated user preferences only mode, where no probabilities are to be applied. If the system notes that the success threshold is below a threshold for these time slots, it may prompt the user to notify him or her of the low success using the preferences. It may then offer to enter a broadcast mode, or to make recommendations based upon the actual success across the usage history. In either case, the monitoring allows the system to adjust operation based upon the success rate of the probabilities being applied, or in accordance with the probability results.

In this manner, a list of ordered selections for contacting a user can be developed and maintained by the system. The list allows the system to reach the user more efficiently and use up less system resources than a broadcast system may use. In the current art, there may exist other types of filtering applied to incoming calls may be employed. These may include policy-based filtering, such as whether a caller is on the ‘whitelist’ for a person or the ‘blacklist,’ where whitelist member calls are allowed through and blacklist member calls are not. This may also include state-based methods, such as ‘do not disturb’ and calendaring systems where the user can designate whether or not the user is reachable at a give time. The embodiments of this invention would be used after these types of processes are applied, based upon calls that will be allowed through whatever previous filtering has been applied.

Thus, although there has been described to this point a particular embodiment for a method and apparatus for predictive call routing, it is not intended that such specific references be considered as limitations upon the scope of this invention except in-so-far as set forth in the following claims.

What is claimed is:

1. A network device, comprising:
a user interface to allow users to specify at least one contact device during a period of time;
a predictor that predicts a probability of contact the user through at least one contact device;
a first port to receive calls intended for the user;
a second port to send contact signals to at least one contact device, depending upon a user specification;
a processor to:
determine connection information based upon the contact device at which the user responds to the contact signal; and
transmit the connection information to the predictor to allow the predictor to update its probability predictions.

2. The network device of claim 1, the device further comprising a memory to store probability data.

3. The network device of claim 1, the user interface further to allow the user to select a predictive mode.

4. The network device of claim 1, the contact device selected from the group comprised of:
pager, cellular phone, landline phone, computer, personal digital assistant, and mobile computing device.

5. The network device of claim 1, the contact signal further comprising: a phone call, a fax signal, an instant message, and a video call.

6. A method of contacting a user, comprising:
receiving a call for a user at a first device;
accessing user preferences for contacting the user;
predicting a probability on contacting the user by at least one contact device based upon the user preferences and previous successful contacts;
transmitting a contact signal to the at least one device having the highest probability;
determining the success or failure of the signal; and
updating probability data used in the predicting.

7. The method of claim 6, receiving a call further comprising receiving one of the group comprised of: a phone call, a fax signal, an instant message and a video call.

8. The method of claim 6, accessing user preferences further comprising accessing an indicator for predictive routing.

9. The method of claim 6, accessing user preferences further comprising accessing a list of user preferences for a particular time period.

10. The method of claim 6, accessing user preferences further comprising accessing a list of user preferences and an indicator for predictive routing.

11. The method of claim 6, predicting a probability further comprising applying Bayes's Theorem to the contact devices.

12. The method of claim 6, transmitting a contact signal further comprising transmitting one of the group comprised of: a phone call, a fax signal, an instant message or a video call.

13. The method of claim 6, determining the success or failure further comprising determining at what device the user responds to the signal.

14. The method of claim 6, updating the probability data further comprising raising the probability of a device at which the user responds to the call.

15. The method of claim 6, updating the probability data further comprising:
determining that a success rate is below a failure threshold after a predetermined period of time; and
querying the user to either enter a broadcast system, or choose a best mode of prediction.

16. The method of claim 6, updating the probability data further comprising:
determining that a success rate is above a success threshold; and
ordering a probability for each contact device based upon past successes.

17. The method of claim 6, transmitting a contact signal further comprising:
determining a first set of contact devices having a probability of success within a predetermined range; and
sending multiple contact signals to contact devices in the first set in parallel; and
if no success occurs, determining a next set of contact devices having a probability of success within a next range.

18. The method of claim 17, the method further comprising repeating the determining and sending processes until a success occurs.

19. The method of claim 17, the method further comprising altering the ranges depending upon successes.

20. A network device, comprising:
a means for allowing users to specify at least one contact device during a period of time;
a means for predicting a probability of contact the user through at least one contact device;
a means for receiving calls intended for the user;
a means for sending contact signals to at least one contact device, depending upon a user specification;
a means for:
determining connection information based upon the contact device at which the user responds to the contact signal; and
transmitting the connection information to the predictor to allow the predictor to update its probability predictions.

21. The network device of claim 20, the device further comprising a means for storing probability data.

22. An article of machine-readable code containing instructions that, when executed, cause the machine to:
receive a call for a user at a first device;
access user preferences for contacting the user;
predict a probability on contacting the user by at least one contact device based upon the user preferences and previous successful contacts;
transmit a contact signal to the at least one device having the highest probability;
determine the success or failure of the signal; and
update probability data used in the predicting.

23. The article of claim 22, the code causing the machine to update the probability data further causing the machine to:
determine that a success rate is below a failure threshold after a predetermined period of time; and
query the user to either enter a broadcast system, or choose a best mode of prediction.

24. The article of claim 22, the code causing the machine to update the probability data further causing the machine to:
determining that a success rate is above a success threshold; and
ordering a probability for each contact device based upon past successes.

25. The article of claim 22, the code causing the machine to update the probability data further causing the machine to transmit a contact signal further comprising:
determine a first set of contact devices having a probability of success within a predetermined range;
send multiple contact signals to contact devices in the first set in parallel; and
if no success occurs, determine a next set of contact devices having a probability of success within a next range.
